(19) United States
(12) Patent Application Publication
(10) Pub. No.: US 2025/0386794 A1
(43) Pub. Date: Dec. 25, 2025

(54) CLIMATE CONTROLLED KENNEL

(71) Applicant: Bloom and Wilkerson Enterprises LLC, Rancho Santa Margarita, CA (US)

(72) Inventor: Charles Asher, Santa Clarita, CA (US)

(21) Appl. No.: 19/228,270

(22) Filed: Jun. 4, 2025

Related U.S. Application Data
(60) Provisional application No. 63/663,462, filed on Jun. 24, 2024.

(51) Int. Cl. A01K 1/00; A01K 1/03; A01K 29/00

(52) U.S. Cl. CPC A01K 1/0047; A01K 1/034; A01K 29/005; A01K 1/0035

(57) ABSTRACT

A climate-controlled animal kennel has an enclosed housing structure with a base, a plurality of sidewalls extending upwardly from the base, and a top cover that together define an interior chamber sized to contain an animal. An access opening is formed in one or more of the sidewalls of the housing structure, and sized and shaped to permit ingress and egress of the animal. A closure is operably mounted on the enclosed housing structure, the closure being movable between an open position and a closed position, and wherein the closure substantially seals the access opening when in the closed position. A kennel control system controls temperature within the interior chamber of the enclosed housing structure, and an HVAC unit is operably mounted to the housing structure and configured to regulate the temperature within the interior chamber responsive to the kennel control system. An airflow opening is formed in the enclosed housing structure and enables airflow from the HVAC unit into the enclosed housing structure. A filter covers the airflow opening, and a power management system is operably coupled to the HVAC unit.

### CROSS-REFERENCE TO RELATED APPLICATIONS

This application for a utility patent claims the benefit of U.S. Provisional Application No. 63/663,462, filed Jun. 24, 2024.

### BACKGROUND OF THE INVENTION

### Field of the Invention

This invention relates generally to animal kennels, and more particularly to a climate controlled kennel.

### Description of Related Art

Typical animal kennels have perforated walls to allow plenty of ventilation. A disadvantage of this construction is that such kennels are not climate controlled, and they also allow a great deal of light and noise, which can be upsetting to the animal, and interfere with sleep and rest.

There is a need in the art not only for climate-controlled kennels that significantly exclude light and noise, so that animals, in particular working animals, are able to rest in a safe, healthy, and relaxing environment.

### SUMMARY OF THE INVENTION

The present invention teaches certain benefits in construction and use which give rise to the objectives described below.

The present invention provides a climate-controlled animal kennel, comprising an enclosed housing structure having a base, a plurality of sidewalls extending upwardly from the base, and a top cover that together define an interior chamber sized to contain an animal. An access opening is formed in one or more of the sidewalls of the housing structure, and sized and shaped to permit ingress and egress of the animal. A closure is operably mounted on the enclosed housing structure, the closure being movable between an open position and a closed position, and wherein the closure substantially seals the access opening when in the closed position. A kennel control system controls temperature within the interior chamber of the enclosed housing structure, and an HVAC unit is operably mounted to the housing structure and configured to regulate the temperature within the interior chamber responsive to the kennel control system. An airflow opening is formed in the enclosed housing structure and enables airflow from the HVAC unit into the enclosed housing structure. A filter covers the airflow opening, and a power management system is operably coupled to the HVAC unit.

A primary objective of the present invention is to provide a climate-controlled kennel having advantages not taught by the prior art.

Another objective is to provide a kennel that is climate-controlled and maintains a safe and healthy environment for the animal.

Another objective is to provide a kennel that provides insulation against temperature, light, sound, so that the environment is optimal for the health and safety of the animal.

A further objective is to provide a climate-controlled kennel having a control system that monitors the kennel and communicates with a mobile application of a user, to ensure the health and safety, and provide alerts in the event of any failures or detected unhealthy conditions.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention.

FIG. 1 is a perspective view of a climate-controlled animal kennel according to one embodiment of the present invention.

FIG. 2 is a rear perspective partially exploded view thereof.

FIG. 3 is a block diagram thereof.

FIG. 4 is a perspective view of the interior of a control box of the climate-controlled animal kennel.

FIG. 5 is a perspective view of the interior of a power supply box of the climate-controlled animal kennel.

### DETAILED DESCRIPTION OF THE INVENTION

The above-described drawing figures illustrate the invention, a climate controlled kennel for providing shelter to an animal.

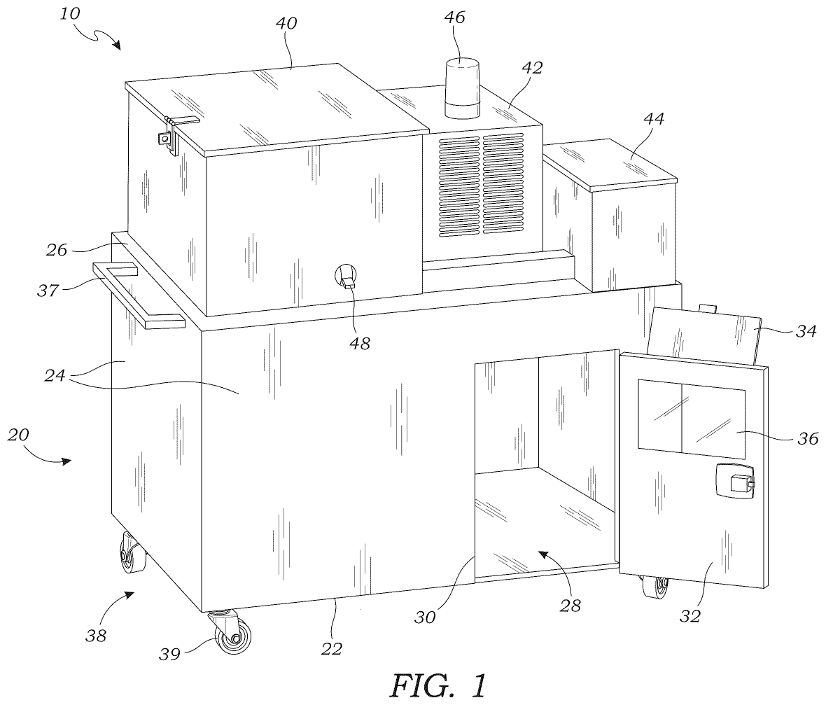

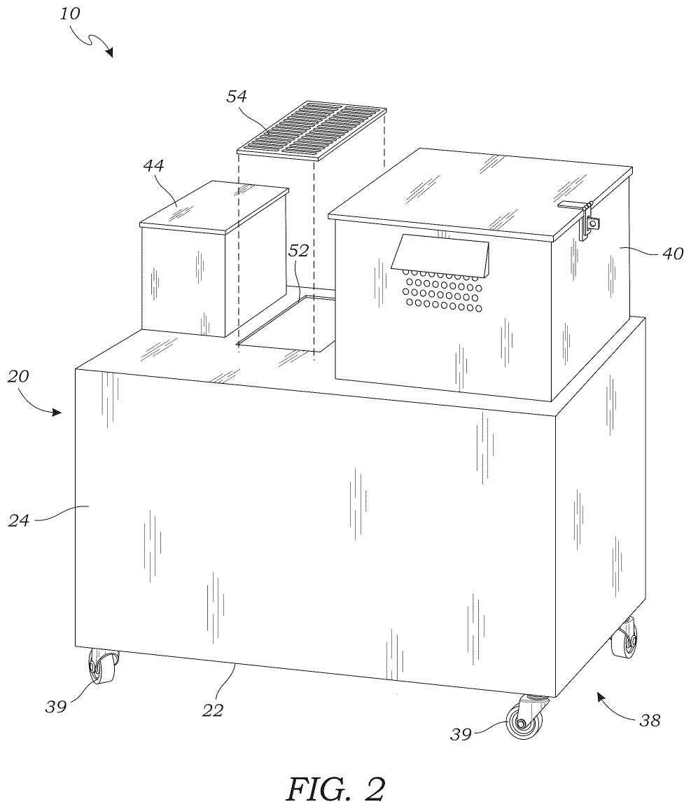

FIG. 1 is a perspective view of a climate-controlled animal kennel 10 according to one embodiment of the present invention, and FIG. 2 is a rear perspective partially exploded view thereof. As shown in FIGS. 1-2, the kennel 10 comprises an enclosed housing structure 20 adapted to house at least one animal (such as a dog or cat, though any animal may be housed) within a climate controlled interior chamber 28. The interior chamber 28 provides a carefully controlled environment that provides a controlled temperature, as well as protection against exposure to light and noise which may lead to overstimulation. This may be especially useful for protecting working animals, and also in the context of transportation environments including airport, terminal, freight, cargo, baggage, vehicle, bus, ferry and rail. Other features may be included to further enhance the safety and/or comfort of the animal, as discussed in greater detail below.

As shown in FIGS. 1-2, the enclosed housing structure 20 has a base 22, a plurality of sidewalls 24 extending upwardly from the base 22, and a top cover 26 that together define an interior chamber 28 sized to contain the animal. In some embodiments, there are four sidewalls 24 to form a generally rectangular housing, but in other embodiments, any suitable number of sidewalls and shapes may be constructed. The housing structure 20 forms the interior chamber 28 for containing an animal, which may be constructed in a wide range of sizes, depending on the desires of the consumer. In various embodiments, the interior chamber 28 may include features for enhancing comfort of the animal, such as a carpeted floor, a bedding area, a shelf for napping or perching, built-in water/food dishes, etc., or alternatively the interior chamber 28 may be generally empty.

An access opening 30 is formed in one or more of the sidewalls 24 of the housing structure 20, and sized and shaped to permit ingress and egress of the animal. A closure 32 is operably mounted on the enclosed housing structure 20, the closure 32 being movable between an open position and a closed position, and wherein the closure 32 substantially seals the access opening 30 when in the closed position.

For the purposes of this application, the term “substantially seals” is defined to mean that the closure 32 prevents light from entering the interior chamber 28. This provides the animal with reduced sensory stimulation, which may be desired for resting animals, such as working dogs, though other animals may use the kennel to the same effect. The enclosed housing structure 20 may further be formed of or lined with insulating material to improve thermal control and/or minimize sound. In this embodiment, the closure 32 covering the access opening 30 is in the form of a sound-insulating door 32. The combination of reduced light and sound may be desired for animals who need to rest or who need to be protected from loud or stressful environments.

In this embodiment, the sound-insulated door 32 is hingeably mounted to the housing structure 20, but the door 32 may be slidably mounted, fully removable, or mounted via a different means. The door 32 may comprise a two-panel aluminum construction with insulation material disposed between the panels. Alternative closures may be implemented, such as a plurality of plastic flaps, a carousel or swinging door mechanism, a motion sensing door, etc., which should be considered within the scope of the present invention. In some embodiments, the opening may be adapted to change between closures, i.e., seasonal closures, so that there is a “winter door” and a “summer door,” or similar. Furthermore, a ramp or stairs (not shown) may be installed in front of the opening to assist the animal with entering the interior chamber 28.

Also illustrated is an openable hatch 34 in the door 32, the openable hatch 34 being configured to allow external viewing into the interior chamber 28. In this manner, it is possible to look inside of the interior chamber 28 without affecting the temperature, and while minimizing the amount of light that enters the interior chamber 28. In some embodiments, the openable hatch 34 includes a pane of plexiglass 36 for viewing, though other transparent substrates may be used, or no additional material is included behind the openable hatch 34. Furthermore, in some iterations, the openable hatch 34 is excluded.

In some embodiments, the housing structure 20 may further include a set of feet 38 extending downwardly from the base 22 to support the kennel above ground level. In the embodiment of FIG. 1, at least one of the feet 38 includes a wheel 39, and the kennel further comprises a handle 37 to enable rolling movement of the kennel 10. Any number of wheels and/or feet may be included, wherein the feet 38 may include a locking mechanism to prevent unwanted rolling.

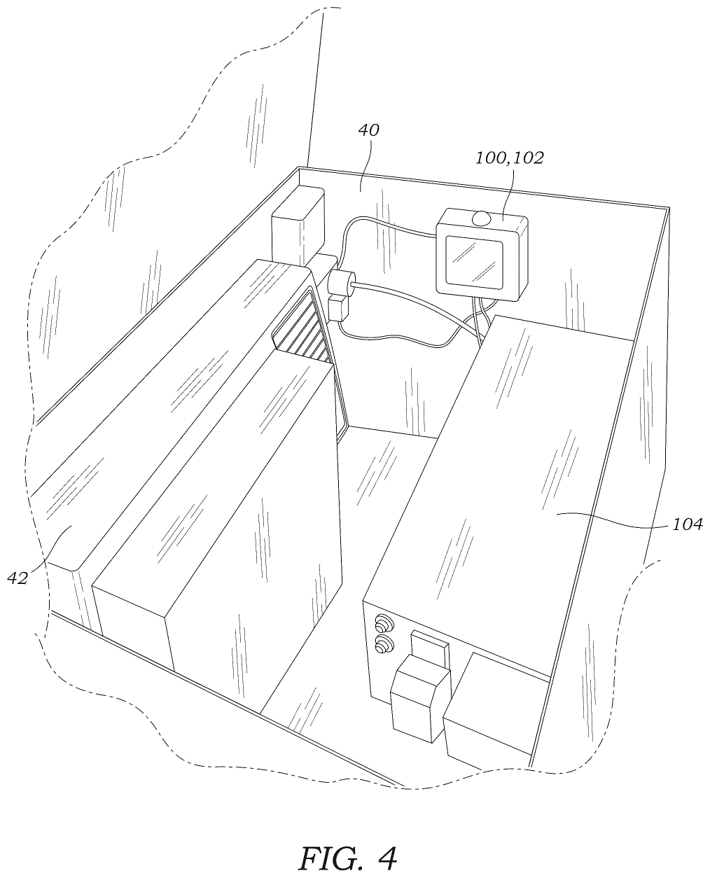

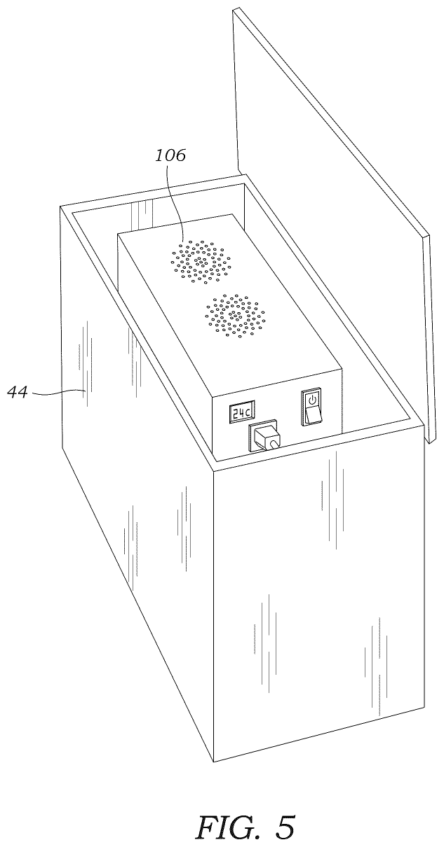

As shown in FIGS. 1-2, in this embodiment, a control box 40, an HVAC unit 42, a power supply box 44, and an alarm light 46 may be mounted to the top cover 26 of the enclosed housing structure 20. The HVAC unit 42 and control box 40 may be configured to minimize operational noise. The exterior of the control box 40 may include a switch 48 for turning DC power backup on or off, wherein the control box 40 is connected to the power supply box 44. The interior components of the control box 40 and power supply box 44 are best shown in FIGS. 4-5 and discussed further below.

As shown in FIG. 2, an airflow opening 52 is formed in the enclosed housing structure 20 and enables airflow from the HVAC unit 42 into the enclosed housing structure 20. A filter 54 covers the airflow opening 52.

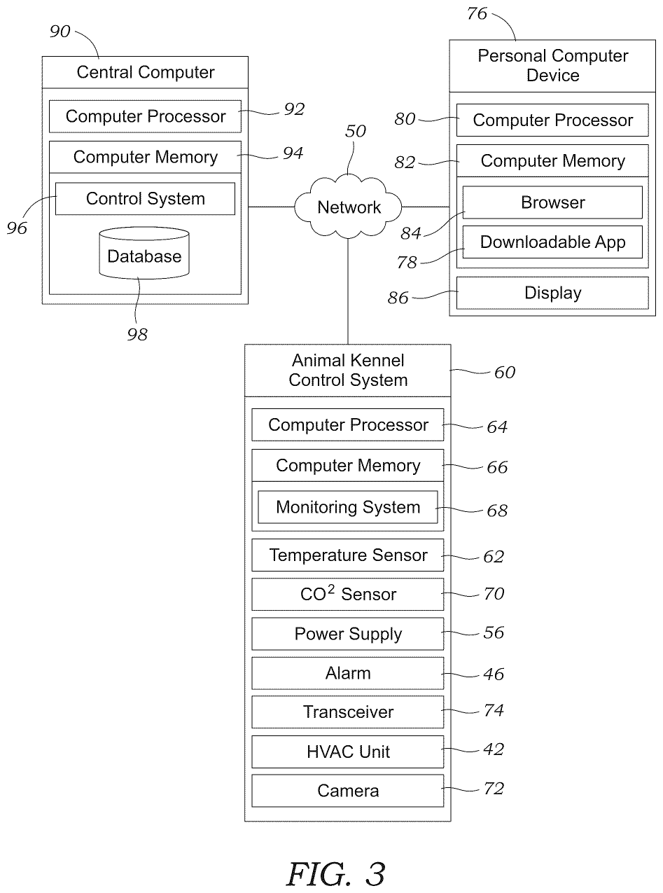

FIG. 3 is a block diagram of the climate-controlled animal kennel 10. As shown in FIG. 3, the climate-controlled animal kennel 10 may include an animal kennel control system 60 in communication with a central computer 90 and a personal computer device 76 via a network 50. The animal kennel control system 60 is included with the housing structure 20 of the climate-controlled animal kennel 10 and controls temperature within the interior chamber 28 of the enclosed housing structure 20. The HVAC unit 42 is operably mounted to the housing structure 20 and configured to regulate the temperature within the interior chamber 28 responsive to the kennel control system 60. In this embodiment, a temperature sensor 62 is operably mounted in the enclosed housing structure 20 to detect a temperature in the interior chamber 28, wherein the HVAC unit 42 is configured to operate based on the temperature detected by the temperature sensor 62. Furthermore, a power management system 56 is operably coupled to the HVAC unit 42. In use, the HVAC unit 42 may be set to a temperature prior to leaving the animal for a period of time, wherein the unit may have an “economy mode” so it turns on as-needed.

As illustrated, the animal kennel control system 60 includes a computer processor 64 and a computer memory 66 for operating the various systems of the invention. The computer memory 66 stores executable code in the form of an environmental monitoring system 68 configured to detect temperature and carbon dioxide levels within the interior chamber 28 via the temperature sensor 62 and a carbon dioxide sensor 70, and to trigger an alarm in the event that the temperature or the carbon dioxide levels move out of predetermined ranges of acceptable temperatures or carbon dioxide levels. The alarm may be in the form of the alarm light 46 shown in FIG. 1, an audio warning, a wireless transmittal to the personal computer device 76 and/or central computer 90, or a combination of these. In some embodiments, the environmental monitoring system 68 is also responsive to at least one camera 72 positioned to monitor the interior chamber 28, wherein certain movements from within the interior chamber 28 trigger an alarm or alert. The camera 72 may be an infrared camera to record the dark interior chamber 28. The wireless transmittal may be enabled by a wireless communication interface (transceiver) 74 configured to transmit a video feed to a remote device such as the personal computer device 76. Similarly, there may also be a two-way audio system.

The kennel control system 60 is configured to wirelessly receive remote instructions from a mobile application 78. In this embodiment, the personal computer device 76 includes a computer processor 80 and a computer memory 82, the computer memory 82 storing a browser 84 and/or the mobile application 78. The personal computer device 76 further includes a display 86 for showing a user information about the kennel control system 60. In some embodiments, the personal computer device 76 is in the form of a smart phone, but any suitable device may be used, including tablets, desktop computers, smart glasses, smart watches, etc., or any other form of device capable of wirelessly receiving and displaying information from the kennel control system 60.

As shown in FIG. 3, the climate-controlled animal kennel 10 may further include the central computer 90, which comprises a computer processor 92 and a computer memory 94. The computer memory 94 stores executable code in the form of a central control system 96, which communicates with the environmental monitoring system 68 and/or the mobile application 78 via the network 50.

The computer memory 94 further includes a database 98 which may store information such as past temperature logs, video recordings, user logins, etc., as determined by one skilled in the art.

For purposes of this application, the terms “computer,” “computer device,” “server,” and similar terms, refer to a device and/or system of devices that include at least one computer processor, and some form of computer memory having a capability to store data. The computer may comprise hardware, software, and firmware for receiving, storing, and/or processing data as described below. For example, a computer may comprise any of a wide range of digital electronic devices, including, but not limited to, a server, a desktop computer, a laptop, a smart phone, a tablet, or any form of electronic device capable of functioning as described herein.

The term “computer processor” as used herein refers to an electrical component that performs operations on an external data source, such as a computer memory, typically in the form of a microprocessor, although any equivalent structure may be used.

The term “computer memory” as used herein refers to any tangible, non-transitory storage that participates in providing instructions to a processor for execution. Such a medium may take many forms, including but not limited to, non-volatile media, volatile media, and any equivalent media known in the art. Non-volatile media includes, for example, ROM, magnetic media, and optical storage media. Volatile media includes, for example, DRAM, which typically serves as main memory. Common forms of computer memory include, for example, hard drives and other forms of magnetic media, optical media such as CD-ROM disks, as well as various forms of RAM, ROM, PROM, EPROM, FLASH-EPROM, solid state media such as memory cards, and any other form of memory chip or cartridge, or any other medium from which a computer can read. While several examples are provided above, these examples are not meant to be limiting, but illustrative of several common examples, and any similar or equivalent devices or systems may be used that are known to those skilled in the art.

The term “database” as used herein, refers to any form of one or more (or combination of) relational databases, object-oriented databases, hierarchical databases, network databases, non-relational (e.g. NoSQL) databases, document store databases, in-memory databases, programs, tables, files, lists, or any form of programming structure or structures that function to store data as described herein.

The network 50 may include any device or system for communicating information from one computer device to another. For example, a global computer network (e.g., the Internet) may be used, including any form of local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. The network 50 may further include any form of wireless network, including cellular systems, WLAN, Wireless Router (WR) mesh, or the like. Access technologies such as 2G, 3G, 4G, and future access networks may enable wide area coverage for mobile devices. In essence, the wireless network may include any wireless communication mechanism known in the art by which information may travel between computers of the present system.

FIG. 4 is a perspective view of the interior of the control box 40 of the climate-controlled animal kennel 10. As shown in FIG. 4, the control box 40 includes a display panel 100 for the carbon dioxide sensor 70, and a display panel 102 for the temperature sensor 62, so the control box 40 may be opened to view the readings from the interior chamber 28. The HVAC unit 42 may partially extend into the control box 40, over the airflow opening 52 and filter 54. The control box 40 may further include an inverter and primary battery 104 of the power management system 56, which are operably connected with the electronic components of the climate-controlled animal kennel 10. The computer processor 64, computer memory 66, and transceiver 74 may be integrated within any of components illustrated in FIG. 3, or any other suitable location in/on the housing structure 20. In some embodiments, a display screen (not shown) may be included within the control box 40, or elsewhere on the housing structure 20, for showing a live feed from the camera 72 within the interior chamber 28. Other forms of readings may be taken from the interior chamber 28 and displayed (i.e., on the personal computer device 76 or on a display of the housing), such as readings from motion sensors, light sensors, touch tensors, humidity sensors, air pressure sensors, microphones, or any other sensor that may be used to gather information from within the interior chamber 28.

FIG. 5 is a perspective view of the interior of the power supply box 44 of the climate-controlled animal kennel 10. As shown in FIG. 5, the power management system 56 further comprises a backup battery 106 operably connected to the control box 40. The switch 48 shown in FIG. 1 may be set to automatically activate the backup battery upon failure of the primary battery 104. The backup battery 106 is also configured to maintain continuous operation of the environmental monitoring system 68 during power outages.

In use, the door 32 over the access opening 30 is opened, the animal enters therethrough, and the door 32 is closed behind them. The HVAC unit 42 may have pre-conditioned the interior chamber 28 prior to the animal entering, or it may then begin to condition the air (heating or cooling) according to set temperatures. At this point, the monitoring system is continuously monitoring input from the carbon dioxide sensor, the temperature sensor 62, the camera, and any other deployed sensors. The information may be transmitted to the personal computer device 76 and the central computer 90 via the network 50. Furthermore, the filter 54 is continuously filtering air that is allowed into the interior chamber 28. In this manner, the animal is kept in a quiet, dark, and temperature-controlled environment for periods where the animal is not working, or during periods where it is desired to reduce the input of external stimuli. A person may also wish to open the openable hatch 34 to look into the interior chamber 28 periodically, or to allow some light into the chamber 28. In the case where the temperature, carbon dioxide levels, movement, sound, etc. are above a predetermined threshold, the alarm may sound/light, or an alert may be sent to the personal computer device 76, so the issue can be immediately addressed.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A climate-controlled animal kennel, comprising:
an enclosed housing structure comprising a base, a plurality of sidewalls extending upwardly from the base, and a top cover that together define an interior chamber sized to contain an animal;
an access opening formed in one or more of the sidewalls of the housing structure, and sized and shaped to permit ingress and egress of the animal;
a closure operably mounted on the enclosed housing structure, the closure being movable between an open position and a closed position, and wherein the closure substantially seals the access opening when in the closed position;
a kennel control system for controlling temperature within the interior chamber of the enclosed housing structure;
an HVAC unit operably mounted to the housing structure and configured to regulate the temperature within the interior chamber responsive to the kennel control system;
an airflow opening in the enclosed housing structure that enables airflow from the HVAC unit into the enclosed housing structure;
a filter that covers the airflow opening; and
a power management system operably coupled to the HVAC unit.

2. The kennel of claim 1, further comprising a temperature sensor operably mounted in the enclosed housing structure to detect a temperature in the interior chamber, wherein the HVAC unit is configured to operate based on the temperature detected by the temperature sensor.

3. The kennel of claim 1, wherein the power management system comprises an inverter and a battery.

4. The kennel of claim 1, further comprising a set of feet extending downwardly from the base to support the kennel above ground level.

5. The kennel of claim 4, wherein at least one of the feet includes a wheel, and wherein the kennel further comprises a handle to enable rolling movement of the kennel.

6. The kennel of claim 1, further comprising an environmental monitoring system configured to detect temperature and carbon dioxide levels within the interior chamber, and to trigger an alarm in the event that the temperature or the carbon dioxide levels move out of predetermined ranges of acceptable temperatures or carbon dioxide levels.

7. The kennel of claim 1, wherein the closure covering the access opening includes a sound-insulated door.

8. The kennel of claim 7, wherein the sound-insulated door includes an openable hatch configured to allow external viewing into the interior chamber.

9. The kennel of claim 1, wherein the kennel control system is configured to wirelessly receive remote instructions from a mobile application.

10. The kennel of claim 1, wherein the housing structure is formed of or lined with insulating material to improve thermal control and/or minimize sound.

11. The kennel of claim 1, further comprising a camera positioned to monitor the interior chamber, and a wireless communication interface configured to transmit a video feed to a remote device.
